(19) United States
(12) Patent Application Publication
(10) Pub. No.: US 2023/0381047 A1
(43) Pub. Date: Nov. 30, 2023

(54) Adjustable Calf Stretcher

(71) Applicant: Syed Uzair Jawed, London (GB)

(72) Inventor: Syed Uzair Jawed, London (GB)

(21) Appl. No.: 18/321,588

(22) Filed: May 22, 2023

Related U.S. Application Data
(60) Provisional application No. 63/345,306, filed on May 24, 2022.

(51) Int. Cl. A61H 1/02

(52) U.S. Cl. CPC A61H 1/0237; A61H 2201/164; A61H 2201/0157; A61H 2201/1253; A61H 2201/0192; A61H 2201/1635; A61H 2201/0161

(57) ABSTRACT

An adjustable calf stretcher is an apparatus that helps treat various physical ailments by enabling the safe and efficient stretching of the calf muscle area. The apparatus includes a foot-bracing platform, a floor-bracing base, and a tilt-and-lock mechanism. The foot-bracing platform is designed to accommodate the user's feet when the user is stretching using the apparatus. The tilt-and-lock mechanism enables the quick adjustment of the tilt angle of the foot-bracing platform to enable the user to target different muscles while stretching with the apparatus. The tilt-and-lock mechanism also secures the foot-bracing platform to the floor-bracing base while enabling the quick adjustment of the tilt angle of the foot-bracing platform. The floor-bracing base enables the safe placement of the apparatus on the ground without having to secure the apparatus to an external object so that the user can safely stretch. The floor-bracing base also facilitates the transportation of the apparatus.

The current application claims a priority to the U.S. provisional patent application Ser. No. 63/345,306 filed on May 24, 2022.

### FIELD OF THE INVENTION

The present invention relates generally to exercise and fitness equipment. More specifically, the present invention provides a portable and adjustable calf stretcher that is safe and easy to adjust.

### BACKGROUND OF THE INVENTION

Stretching is a vital activity to properly maintain muscles and joints. Stretching has been shown to help with muscle tightness and even subside certain pain within the body. This can be accomplished with standard bodyweight stretching to a certain degree. Without the use of specialized equipment or machines, bodyweight stretching can only assist the user in certain areas. For specific injuries and pain, stretching in conjunction with specialized equipment is needed to target the specific areas that are hard or impossible to accomplish without equipment. Much of the equipment available today allows the user to get a deeper stretch with muscles already targeted in standard body weight stretching without equipment. Unfortunately, most equipment does not allow the user to target specific areas that are seldom neglected during stretching.

An objective of the present invention is to provide users with an adjustable calf stretcher to help the user to properly stretch the calf muscle area. The present invention includes an adjustable structure that can easily be adjusted to accommodate several tilt angles for more efficient stretching. Another objective of the present invention is to provide an adjustable calf stretcher that enables the safe stretching of the calf muscle area while protecting the Achilles tendon. Another objective of the present invention is to provide an adjustable calf stretcher that is portable so that the adjustable calf stretcher can be utilized at any location. Additional features and benefits of the present invention are further discussed in the sections below.

### SUMMARY OF THE INVENTION

The present invention is an adjustable calf stretcher designed to help with stretching the calf area safely and efficiently. The adjustable calf stretcher is designed as a portable and adjustable structure that can be easily transported and set up for the safe and efficient stretching of the calf muscle area and other muscles. In the preferred embodiment, the adjustable calf stretcher can be easily adjusted to change the tilt angle of a foot-bracing platform where the user's feet can be placed. The foot-bracing platform is designed to accommodate the user's feet without obstructing the user's stretching. The tilt angle of the foot-bracing platform can be adjusted using a tilt-and-lock mechanism that keeps the foot-bracing platform at a specific tilt angle with a floor-bracing base. The tilt-and-lock mechanism enables the easy adjustment of the tilt angle without the use of tools. The floor-bracing base enables the present invention to securely rest on a surface so that the user can safely and efficiently stretch without having to fasten the adjustable calf stretcher to an external object.

### BRIEF DESCRIPTION OF THE DRAWINGS

FIG. 1 is a top-front-left perspective view of the present invention.

FIG. 2 is a bottom-rear-right perspective view of the present invention.

FIG. 3 is a top-front-left exploded perspective view of the present invention.

FIG. 4 is a bottom-front-right exploded perspective view of the present invention.

FIG. 5 is a right exploded view of the present invention, wherein the present invention is shown without a locking rod.

FIG. 6 is a left exploded view of the present invention, wherein the present invention is shown without the locking rod.

FIG. 7 is a left view of the present invention, wherein the present invention is shown at the lowest tilt angle.

FIG. 8 is a left view of the present invention, wherein the present invention is shown at a higher tilt angle.

FIG. 9 is a left view of the present invention, wherein the present invention is shown at the highest tilt angle.

### DETAIL DESCRIPTIONS OF THE INVENTION

All illustrations of the drawings are for the purpose of describing selected versions of the present invention and are not intended to limit the scope of the present invention.

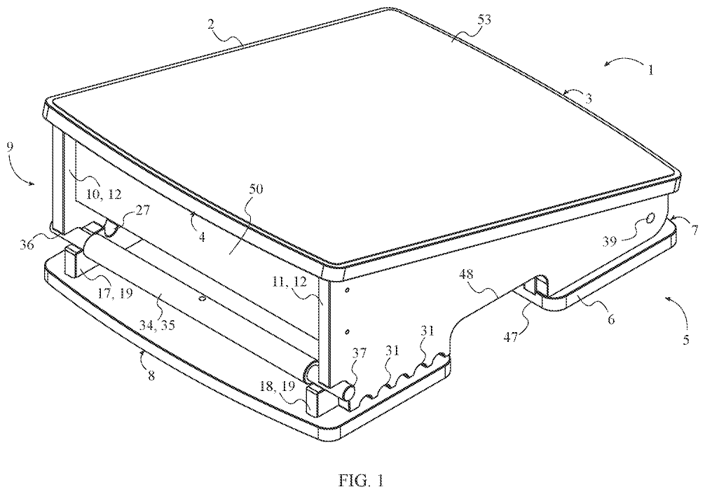

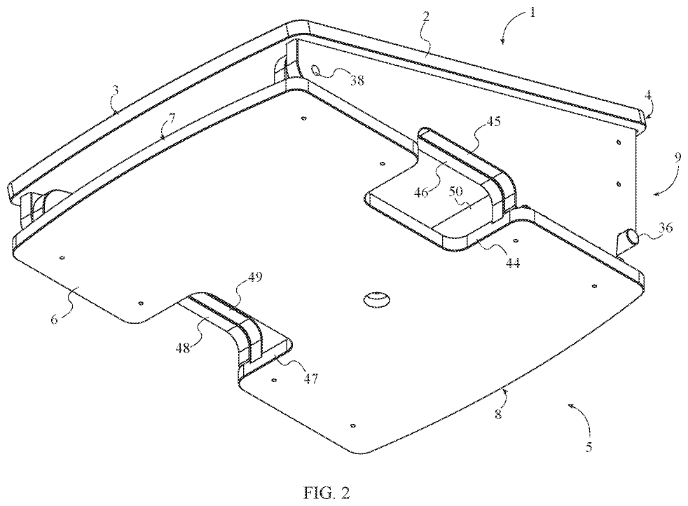

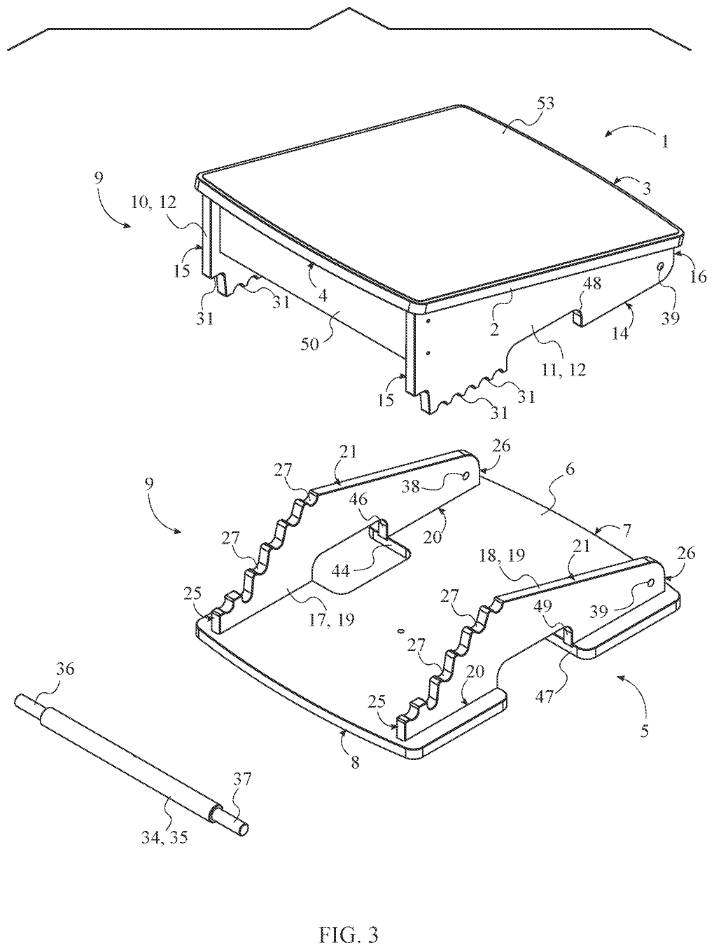

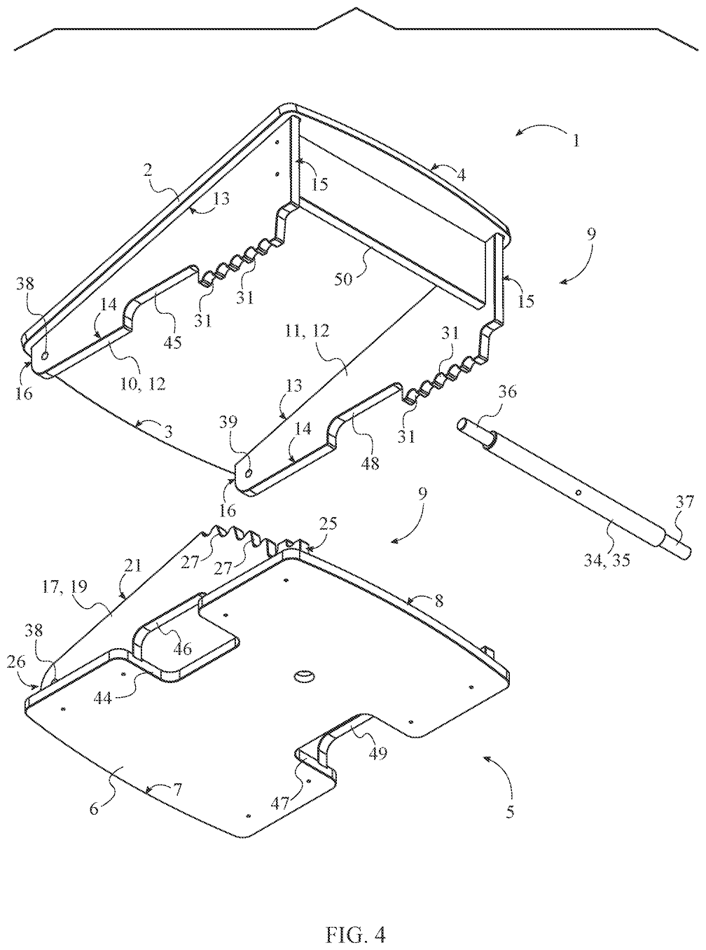

The present invention is an adjustable calf stretcher that enables the safe and efficient stretch of the calf muscle area. The present invention helps treat various physical ailments including, but not limited to, plantar fasciitis, Achilles tendonitis, patellar tendonitis, and hip pain. As can be seen in FIGS. 1 through 4, the present invention comprises a foot-bracing platform 1, a floor-bracing base 5, and a tilt-and-lock mechanism 9. The foot-bracing platform 1 is designed to accommodate the user's feet when the user is stretching using the present invention. The tilt-and-lock mechanism 9 enables the quick adjustment of the tilt angle 43 of the foot-bracing platform 1 to enable the user to target different muscles while stretching. The tilt-and-lock mechanism 9 also secures the foot-bracing platform 1 to the floor-bracing base 5 while enabling the quick adjustment of the tilt angle 43 of the foot-bracing platform 1. The floor-bracing base 5 enables the safe placement of the present invention on the ground without having to secure the present invention to an external object. The floor-bracing base 5 also facilitates the transportation of the present invention.

The general configuration of the present invention enables the user to easily adjust the tilt angle 43 to enable the user to stretch the calf muscle area without risk of hurting other body parts, such as the Achilles tendon. As can be seen in FIGS. 1 through 4, the foot-bracing platform 1 is preferably a thin, flat structure large enough to accommodate the user's feet. The foot-bracing platform 1 is preferably rectangular shaped, but the overall shape of the foot-bracing platform 1 can be modified to meet specific requirements. The foot-bracing platform 1 comprises a platform body 2, a proximal platform edge 3, and a distal platform edge 4. The platform body 2 corresponds to the main structure of the foot-bracing platform 1. The proximal platform edge 3 and the distal platform edge 4 preferably correspond to the shorter opposing edges of the platform body 2. Similarly, the floor-bracing base 5 comprises a base body 6, a proximal base edge 7, and a distal base edge 8. The base body 6 corresponds to the main structure of the floor-bracing base 5. The proximal base edge 7 and the distal base edge 8 preferably correspond to the shorter opposing edges of the base body 6. Further, the tilt-and-lock mechanism 9 comprises a first support wall 10, a second support wall 11, a first extension wall 17, a second extension wall 18, a plurality of base notches 27, a plurality of platform notches 31, and a locking rod 34. The first support wall 10, the second support wall 11, the first extension wall 17, and the second extension wall 18 enable the adjustment of the orientation of the foot-bracing platform 1 from the floor-bracing base 5 at a desired tilt angle 43. The plurality of base notches 27, the plurality of platform notches 31, and the locking rod 34 enable the user to lock the orientation of the foot-bracing platform 1 with the floor-bracing base 5 at the desired tilt angle 43. The plurality of platform notches 31 and the plurality of base notches 27 are preferably notches of different sizes arranged in a gradient to increase or decrease the overall tilt angle 43. The plurality of platform notches 31 and the plurality of base notches 27 are also arranged to engage with the locking rod 34 to secure the desired tilt angle 43.

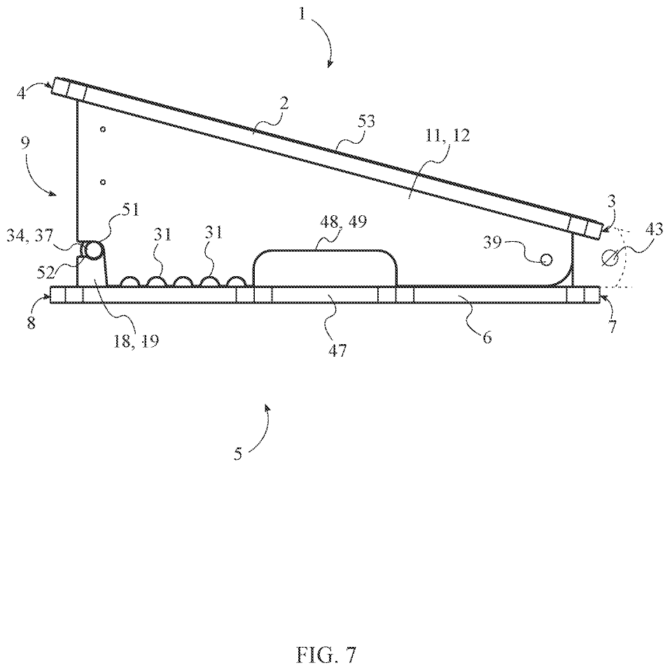

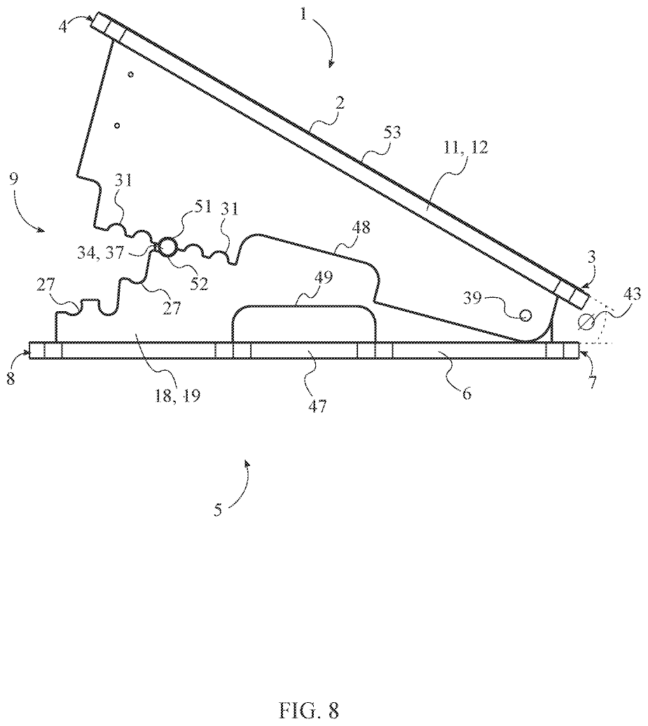

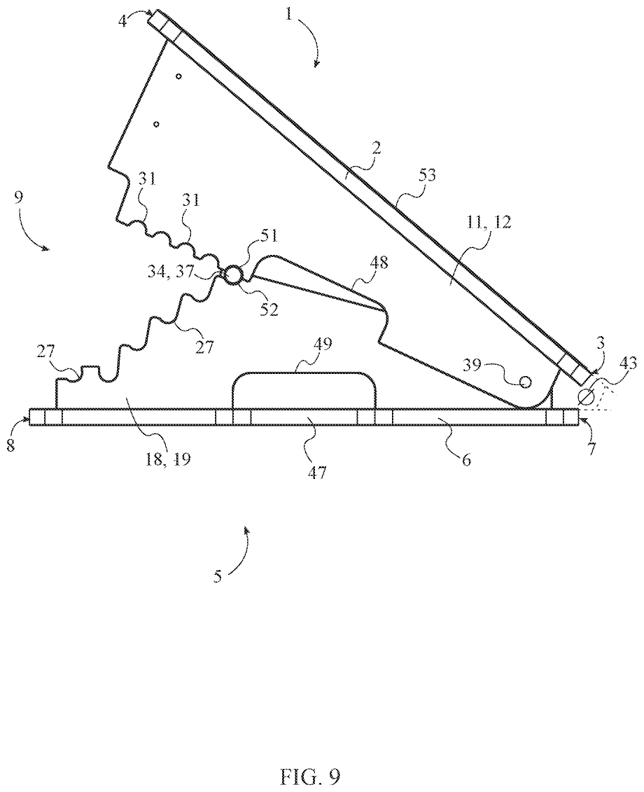

In one embodiment, the present invention can be assembled as follows. As can be seen in FIGS. 1 through 4, the first support wall 10 and the second support wall 11 are mounted onto the platform body 2, offset from each other, to secure the first support wall and the second support wall 11 to the platform body 2. Similarly, the first extension wall 17 and the second extension wall 18 are mounted onto the base body 6, offset from each other, to secure the first extension wall 17 and the second extension wall 18 to the base body 6. Further, the first support wall 10 is hingedly connected to the first extension wall 17, adjacent to the proximal platform edge 3 and the proximal base edge 7, to enable the first support wall 10 to be oriented at a desired tilt angle 43 with the first extension wall 17. Similarly, the second support wall 11 is hingedly connected to the second extension wall 18, adjacent to the proximal platform edge 3 and the proximal base edge 7, to enable the second support wall 11 to be oriented at a similar tilt angle 43 with the second extension wall 18. Further, the plurality of platform notches 31 is integrated into the first support wall 10 and the second support wall 11, adjacent to the distal platform edge 4, to accommodate an end of the locking rod 34. Similarly, the plurality of base notches 27 is integrated into the first extension wall 17 and the second extension wall 18, adjacent to the distal base edge 8, to accommodate the opposite end of the locking rod 34. As can be seen in FIGS. 7 through 9, the plurality of base notches 27 and the plurality of platform notches 31 are preferably arranged in a gradient configuration to enable a range of tilting angles including, but not limited to, from 15 degrees to 40 degrees. In addition, the plurality of base notches 27 and the plurality of platform notches 31 can be arranged to increase or decrease the tilting angle in intervals of five degrees. Furthermore, the locking rod 34 is engaged in between a selected base notch 51 from the plurality of base notches 27 and a corresponding platform notch 52 from the plurality of platform notches 31 to secure the desired tilt angle 43. This way, the user only must engage the locking rod 34 with different base notches and corresponding platform notches to adjust the desired tilt angle 43.

As can be seen in FIGS. 1 through 4, the support walls are preferably arranged so that the adjustment of the tilt angle 43 is not obstructed by the extension walls. To do so, the first support wall 10 and the second support wall 11 can be positioned in between the proximal platform edge 3 and the distal platform edge 4 in a center location on the platform body 2. In addition, the first support wall 10 and the second support wall 11 can be positioned parallel and opposite to each other across the platform body 2 to leave a space for the extension walls. The first support wall 10 and the second support wall 11 are preferably positioned adjacent to the longer edges of the platform body 2. Further, the first support wall 10 and the second support wall 11 are connected perpendicular to the platform body 2. This way, the first support wall 10 and the second support wall 11 do not collide with the extension walls when the user is adjusting the tilt angle 43 of the present invention.

Similar to the support walls, the extension walls are arranged to not obstruct the support walls. As can be seen in FIGS. 1 through 4, the first extension wall 17 and the second extension wall 18 can be positioned in between the proximal base edge 7 and the distal base edge 8 in a center location on the base body 6. In addition, the first extension wall 17 and the second extension wall 18 can be positioned parallel and opposite to each other across the base body 6 to fit in the space between the support walls. The first extension wall 17 and the second extension wall 18 are preferably positioned offset to the longer edges of the base body 6 so that the extension walls do not obstruct the support walls. Further, the first extension wall 17 and the second extension wall 18 are connected perpendicular to the base body 6. This way, both the first extension wall 17 and the second extension wall 18 do not collide with the support walls when the user is adjusting the tilt angle 43 of the present invention.

As can be seen in FIGS. 1 through 4, to prevent the foot-bracing platform 1 from shaking on the floor-bracing base 5 when the user's feet are placed on the foot-bracing platform 1, the first extension wall 17 and the second extension wall 18 are positioned in between the first support wall 10 and the second support wall 11. In addition, the first extension wall 17 is slidably engaged against the first support wall 10. Likewise, the second extension wall 18 is slidably engaged against the second support wall 11. This way, after the user adjusts the tilt angle 43 of the present invention, the foot-bracing platform 1 does not shake on the floor-bracing base 5 due to the weight of the user on the present invention.

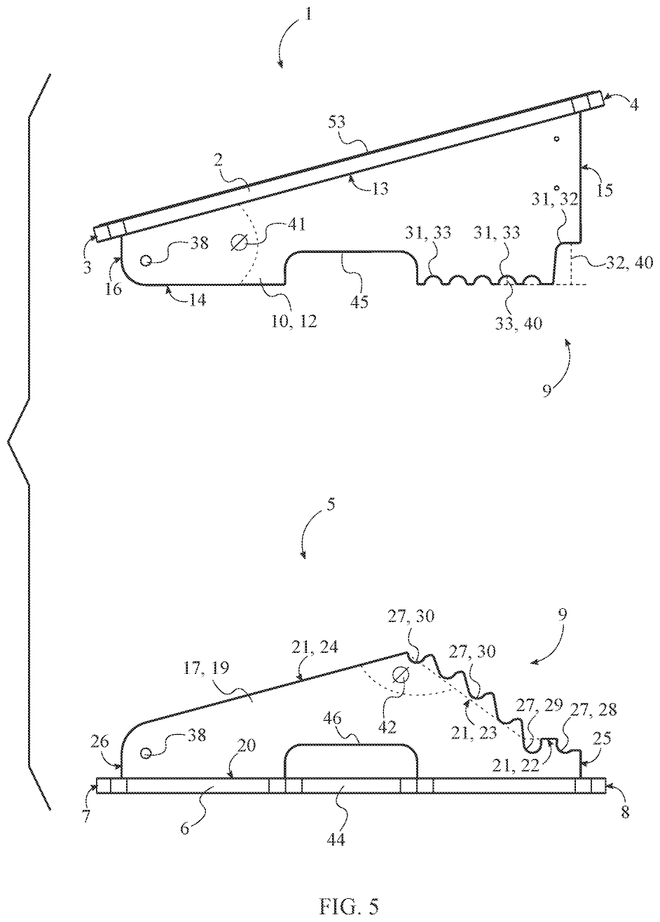

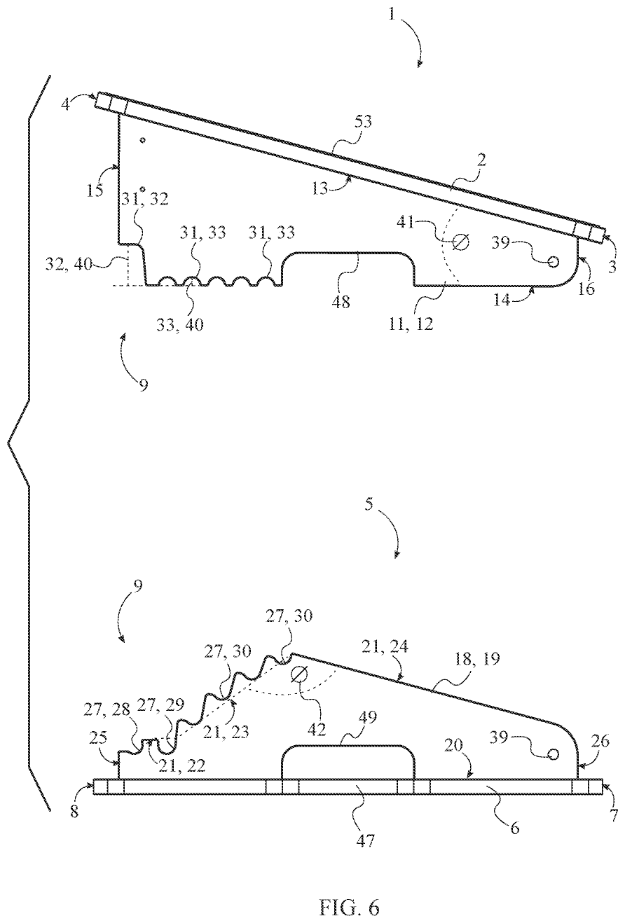

As previously discussed, the support walls and the extension walls are designed to enable the quick adjustment of the tilt angle 43. As can be seen in FIGS. 5 and 6, the first support wall 10 and the second support wall 11 may each comprise a support-wall body 12, a first support-wall lateral edge 13, a second support-wall lateral edge 14, a distal support-wall edge 15, and a proximal support-wall edge 16. The support-wall body 12 preferably corresponds to the main structure of each support wall. The first support-wall lateral edge 13 and the second support-wall lateral edge 14 correspond to the longer edges of the support-wall body 12. On the other hand, the distal support-wall edge 15 and the proximal support-wall edge 16 correspond to the shorter edges of the support-wall body 12. Further, the first support-wall lateral edge 13 and the second support-wall lateral edge 14 are positioned opposite to each other across the support-wall body 12 due to the elongated shape of the support-wall body 12. The first support-wall lateral edge 13 is connected onto the platform body 2 while the second support-wall lateral edge 14 is left free. Further, the distal support-wall edge 15 is positioned adjacent to the distal platform edge 4 while the proximal support-wall edge 16 is positioned adjacent to the proximal platform edge 3. This way, small gaps are left between the distal support-wall edge 15 and the distal platform edge 4 and between the proximal support-wall edge 16 and the proximal platform edge 3. Furthermore, the plurality of platform notches 31 is distributed along the second support-wall lateral edge 14, adjacent to the distal support-wall edge 15, to receive an end of the locking rod 34.

As previously discussed, the plurality of platform notches 31 can be arranged in a gradient to enable the increase or decrease of the tilt angle 43. As can be seen in FIGS. 5 and 6, the plurality of platform notches 31 may comprise a last platform notch 32 and a plurality of other platform notches 33. The last platform notch 32 is preferably the outermost platform notch of the plurality of platform notches 31, while the plurality of other platform notches 33 corresponds to the rest of platform notches. Accordingly, the last platform notch 32 is positioned adjacent to the distal support-wall edge 15 while the plurality of other platform notches 33 is positioned adjacent to the last platform notch 32, opposite to the distal support-wall edge 15. Further, the depth 40 of the plurality of other platform notches 33 is equal to each other, which enables the quick repositioning of the locking rod 34 among the plurality of other platform notches 33. On the other hand, the depth 40 of the last platform notch 32 is greater than the depth 40 of the plurality of other platform notches 33. This way, the last platform notch 32 can serve as the location where the locking rod 34 can be positioned to orient the foot-bracing platform 1 to the lowest tilt angle 43. The greater depth 40 of the last platform notch 32 also enables the present invention to stay overall closed to facilitate the transportation of the present invention. In other embodiments, the plurality of platform notches 31 can be arranged in a different configuration.

As can be seen in FIGS. 5 and 6, to enable the gradient arrangement of the plurality of platform notches 31, the first support-wall lateral edge 13 and the second support-wall lateral edge 14 can be oriented at an acute angle 41 to each other. The acute angle 41 is small enough to enable small increments of the tilt angle 43. Further, the first support-wall lateral edge 13 is longer than the second support-wall lateral edge 14 due to the angular orientation of the first support-wall lateral edge 13 with the second support-wall lateral edge 14. Further, the distal support-wall edge 15 and the proximal support-wall edge 16 are positioned parallel to each other to not obstruct with the adjustment of the tilt angle 43. Furthermore, the distal support-wall edge 15 is longer than the proximal support-wall edge 16 to accommodate the longer length of the first support-wall lateral edge 13. Thus, the support-wall body 12 can be configured to have an overall wedge-shaped design.

To accommodate the design of the support walls, the extension walls are designed with a matching configuration. As can be seen in FIGS. 5 and 6, the first extension wall 17 and the second extension wall 18 may each comprise an extension-wall body 19, a first extension-wall lateral edge 20, a second extension-wall lateral edge 21, a distal extension-wall edge 25, and a proximal extension-wall edge 26. The extension-wall body 19 preferably corresponds to the main structure of each extension wall. The first extension-wall lateral edge 20 and the second extension-wall lateral edge 21 correspond to the longer edges of the extension-wall body 19. On the other hand, the distal extension-wall edge 25 and the proximal extension-wall edge 26 correspond to the shorter edges of the extension-wall body 19. Further, the first extension-wall lateral edge and the second extension-wall lateral edge 21 are positioned opposite to each other across the extension-wall body 19 due to the elongated shape of the extension-wall body 19. The first extension-wall lateral edge 20 is connected onto the base body 6 while the second extension-wall lateral edge 21 is left free. Further, the distal extension-wall edge is positioned adjacent to the distal base edge 8 while the proximal extension-wall edge 26 is positioned adjacent to the proximal base edge 7. This way, small gaps are left between the distal extension-wall edge 25 and the distal base edge 8 and between the proximal extension-wall edge 26 and the proximal base edge 7. Furthermore, the plurality of base notches 27 is distributed along the second extension-wall lateral edge 21, adjacent to the distal extension-wall edge 25, to receive the opposite end of the locking rod 34 so that the user can adjust the tilt angle 43 of the present invention.

Unlike the support walls, the extension walls can have an irregular shape designed to accommodate the overall-wedge shape of the support walls. As can be seen in FIGS. 5 and 6, the second extension-wall lateral edge 21 may comprise a distal straight edge portion 22, a distal slanted edge portion 23, and a proximal slanted edge portion 24. The distal straight edge portion 22 corresponds to the edge portion adjacent to the distal base edge 8, while the proximal slanted edge portion 24 corresponds to the edge portion adjacent to the proximal base edge 7. The distal slanted edge portion 23 corresponds to the edge portion that accommodates the plurality of base notches 27. Further, the plurality of base notches 27 may comprise a last base notch 28, a penultimate base notch 29, and a plurality of other base notches 30. The last base notch 28 is preferably designed to match the last platform notch 32. The penultimate base notch 29 provides a transition between the last base notch 28 and the plurality of other base notches 30. The plurality of other base notches 30 is preferably designed to match the plurality of other platform notches 33. Accordingly, the distal straight edge portion 22 is positioned parallel to the base body 6. In addition, the distal straight edge portion 22 is positioned adjacent to the distal extension-wall edge 25 to accommodate the last base notch 28 and the penultimate base notch 29. Further, the distal slanted edge portion 23 is positioned adjacent to the distal straight edge portion 22, opposite to the distal extension-wall edge 25, to accommodate the plurality of other base notches 30. On the other hand, the proximal slanted edge portion 24 is positioned adjacent to the proximal extension-wall edge 26 to accommodate the platform body 2 when the user adjusts the tilt angle 43. Further, the distal slanted edge portion 23 and the proximal slanted edge portion 24 are oriented at an obtuse angle 42 with each other so that the plurality of other base notches 30 can be arranged in a gradient configuration. The plurality of other base notches 30 is also integrated along the distal slanted edge portion 23 to orient the plurality of other base notches 30 according to the slope of the distal slanted edge portion 23. Furthermore, the last base notch 28 and the penultimate base notch 29 are integrated along the distal straight edge portion 22. This way, the user can adjust the overall tilt angle 43 of the present invention by moving the locking rod 34 along the penultimate base notch 29 and the plurality of other base notches 30. The last base notch 28 serves as the location of the locking rod 34 corresponding to the lowest tilt angle 43 of the present invention that can be used for stretching.

Furthermore, to match the design the of the support walls, the distal extension-wall edge 25 and the proximal extension-wall edge 26 are positioned parallel to each other, as can be seen in FIGS. 5 through 7. This way, a symmetrical structure is formed between the support walls and the extension walls when the present invention is at the lowest tilt angle 43. In addition, the distal extension-wall edge 25 and the proximal extension-wall edge 26 are positioned perpendicular to the first extension-wall lateral edge 20 so that the extension-wall body 19 is overall perpendicular to the base body 6 to provide the best balance to the present invention.

As previously discussed, the support walls are hingedly connected to the extension walls to enable the quick adjustment of the tilt angle 43 of the present invention. As can be seen in FIGS. 1 through 7, the tilt-and-lock mechanism 9 may further comprise a first hinge pin 38 and a second hinge pin 39. The first hinge pin 38 and the second hinge pin 39 secure the support walls to the extension walls while enabling the adjustment of the tilt angle 43 of the present invention. Accordingly, the first support wall and the first extension wall 17 are rotatably connected to each other by the first hinge pin 38. This way, the first support wall 10 is secured to the first extension wall 17 while enabling the adjustment of the tilt angle 43 of the present invention. Similarly, the second support wall 11 and the second extension wall 18 are rotatably connected to each other by the second hinge pin 39. This way, the second support wall 11 is also secured to the second extension wall 18 while enabling the adjustment of the tilt angle 43 of the present invention. Further, the first hinge pin 38 and the second hinge pin 39 are positioned adjacent to the proximal platform edge 3 and the proximal base edge 7. This enables the user to have access to the locking rod 34 from the distal side of the present invention. Furthermore, the first hinge pin 38 and the second hinge pin 39 are aligned to each other to prevent the support walls from colliding with the extension walls while the user adjusts the tilt angle 43.

As previously discussed, the present invention is designed to be portable so that the user can easily transport the present invention. As can be seen in FIGS. 1 through 7, the floor-bracing base 5 may further comprise a first base handle cutout 44, the first support wall 10 may comprise a first support-wall handle cutout 45, and the first extension wall 17 may comprise a first extension-wall handle cutout 46. The first base handle cutout 44, the first support-wall handle cutout 45, and the first extension-wall handle cutout 46 form a large opening adjacent to the floor-bracing base 5 that can be used as a handle to carry the present invention. Accordingly, the first base handle cutout 44 peripherally traverses into the base body 6 to form a large indentation on the base body 6. In addition, the first base handle cutout 44 is positioned in between the proximal base edge 7 and the distal base edge 8, adjacent to the first extension wall 17, in order to center the first base handle cutout 44 along the base body 6. Further, the first support-wall handle cutout 45 laterally traverses into the support-wall body 12 of the first support wall 10 to leave a large indentation on the support-wall body 12 of the first support wall Similarly, the first extension-wall handle cutout 46 laterally traverses into the extension-wall body 19 of the first extension wall 17 to leave a large indentation on the extension-wall body 19 of the first extension wall 17. Furthermore, the first base handle cutout 44, the first support-wall handle cutout 45, and the first extension-wall handle cutout 46 are aligned to each other so that when the user grabs onto the base body 6, the user's arm is not uncomfortably blocked by the first extension wall 17 nor the first support wall 10.

As can be seen in FIGS. 1 through 7, to enable the user to comfortably grab onto the present invention using two hands, the floor-bracing base 5 may further comprise a second base handle cutout 47, the second support wall 11 may comprise a second support-wall handle cutout 48, and the second extension wall 18 may comprise a second extension-wall handle cutout 49. The second base handle cutout 47, the second support-wall handle cutout 48, and the second extension-wall handle cutout 49 form a second large opening adjacent to the floor-bracing base 5 that can be used as a second handle to carry the present invention with two hands. Accordingly, the second base handle cutout 47 peripherally traverses into the base body 6 to form a large indentation on the base body 6. In addition, the second base handle cutout 47 is positioned in between the proximal base edge 7 and the distal base edge 8, adjacent to the second extension wall 18, in order to center the second base handle cutout 47 along the base body 6. Further, the second support-wall handle cutout 48 laterally traverses into the support-wall body 12 of the second support wall 11 to leave a large indentation on the support-wall body 12 of the second support wall 11. Similarly, the second extension-wall handle cutout 49 laterally traverses into the extension-wall body 19 of the second extension wall 18 to leave a large indentation on the extension-wall body 19 of the second extension wall 18. Furthermore, the second base handle cutout 47, the second support-wall handle cutout 48, and the second extension-wall handle cutout 49 are aligned to each other so that when the user grabs onto the base body 6 with the other hand, the user's arm is not uncomfortably blocked by the second extension wall 18 nor the second support wall 11.

As can be seen in FIGS. 1 through 7, to add structural strength to the foot-bracing platform 1, the present invention may further comprise at least one cross support wall 50. The at least one cross support wall 50 is designed to prevent the foot-bracing platform 1 from collapsing due to the load on the platform body 2. To do so, the at least one cross support wall 50 is connected perpendicular to the platform body 2 to secure the at least one cross support wall 50 to the platform body 2. In addition, the at least one cross support wall 50 is positioned in between the pair of support walls so that any shear force on the platform body 2 is supported by the at least one cross support wall 50. In other embodiments, additional structural components can be added to increase the structural strength of the foot-bracing platform 1.

As previously discussed, the locking rod 34 is designed to be easily repositioned so that the user can easily adjust the tilt angle 43 of the present invention. As can be seen in FIGS. 1 through 10, the locking rod 34 may comprise a cylindrical body 35, a first nub 36, and a second nub 37. The cylindrical body 35 preferably corresponds to the main structure of the locking rod 34, while the first nub 36 and the second nub 37 correspond to terminal protrusions of the locking rod 34 that engage with the notches. Accordingly, the first nub 36 is terminally connected to the cylindrical body 35 while the second nub 37 is terminally connected to the cylindrical body 35, opposite to the first nub 36. Then, to lock the overall tilt angle 43 of the present invention, the first nub 36 and the second nub 37 are engaged in between the selected base notch 51 and the corresponding platform notch 52. This way, the user can easily adjust the tilt angle 43 of the present invention by engaging the first nub 36 and the second nub 37 with a different selected base notch 51 and the corresponding platform notch 52. In some embodiments, the locking rod 34 can also be tethered to the base body 6 to prevent the accidental loss of the locking rod 34 when the locking rod 34 is not engaged. In addition, the tethering of the locking rod 34 to the base body 6 can be done using an elastic tether, such as a rubber band, to further keep the locking rod 34 in position to prevent accidental disengagement of the locking rod 34 while the user is stretching.

As can be seen in FIGS. 1 through 10, to further improve the safety of the present invention, the present invention may further comprise an anti-slip layer 53. The anti-slip layer 53 is mounted onto and across the platform body 2, opposite to the first support wall 10 and the second support wall 11, to provide gripping material that prevents the user's feet from accidentally slipping off the foot-bracing platform 1. In other embodiments, the base body 6 may also include gripping material to prevent the floor-bracing base 5 from moving while the user is stretching. Additional safety measures can be included to further protect the user from injuries.

Although the invention has been explained in relation to its preferred embodiment, it is to be understood that many other possible modifications and variations can be made without departing from the spirit and scope of the invention.

What is claimed is:

1. An adjustable calf stretcher device comprising:
a foot-bracing platform;
a floor-bracing base;
a tilt-and-lock mechanism;
the foot-bracing platform comprising a platform body, a proximal platform edge, and a distal platform edge;
the floor-bracing base comprising a base body, a proximal base edge, and a distal base edge;
the tilt-and-lock mechanism comprising a first support wall, a second support wall, a first extension wall, a second extension wall, a plurality of base notches, a plurality of platform notches, and a locking rod;
the first support wall and the second support wall being mounted onto the platform body, offset from each other;
the first extension wall and the second extension wall being mounted onto the base body, offset from each other;
the first support wall being hingedly connected to the first extension wall, adjacent to the proximal platform edge and the proximal base edge;
the second support wall being hingedly connected to the second extension wall, adjacent to the proximal platform edge and the proximal base edge;
the plurality of platform notches being integrated into the first support wall and the second support wall, adjacent to the distal platform edge;
the plurality of base notches being integrated into the first extension wall and the second extension wall, adjacent to the distal base edge; and
the locking rod being engaged in between a selected base notch from the plurality of base notches and a corresponding platform notch from the plurality of platform notches.

2. The adjustable calf stretcher device as claimed in claim 1 comprising:
the first support wall and the second support wall being positioned in between the proximal platform edge and the distal platform edge;
the first support wall and the second support wall being positioned parallel and opposite to each other across the platform body; and
the first support wall and the second support wall being connected perpendicular to the platform body.

3. The adjustable calf stretcher device as claimed in claim 1 comprising:
the first extension wall and the second extension wall being positioned in between the proximal base edge and the distal base edge;
the first extension wall and the second extension wall being positioned parallel and opposite to each other across the base body; and
the first extension wall and the second extension wall being connected perpendicular to the base body.

4. The adjustable calf stretcher device as claimed in claim 1 comprising:
the first extension wall and the second extension wall being positioned in between the first support wall and the second support wall;
the first extension wall being slidably engaged against the first support wall; and
the second extension wall being slidably engaged against the second support wall.

5. The adjustable calf stretcher device as claimed in claim 1 comprising:
the first support wall and the second support wall each comprising a support-wall body, a first support-wall lateral edge, a second support-wall lateral edge, a distal support-wall edge, and a proximal support-wall edge;
the first support-wall lateral edge and the second support-wall lateral edge being positioned opposite to each other across the support-wall body;
the first support-wall lateral edge being connected onto the platform body;
the distal support-wall edge being positioned adjacent to the distal platform edge;
the proximal support-wall edge being positioned adjacent to the proximal platform edge; and
the plurality of platform notches being distributed along the second support-wall lateral edge, adjacent to the distal support-wall edge.

6. The adjustable calf stretcher device as claimed in claim 5 comprising:
the plurality of platform notches comprising a last platform notch and a plurality of other platform notches;
the last platform notch being positioned adjacent to the distal support-wall edge;
the plurality of other platform notches being positioned adjacent to the last platform notch, opposite to the distal support-wall edge;
a depth of the plurality of other platform notches being equal to each other; and
a depth of the last platform notch being greater than the depth of the plurality of other platform notches.

7. The adjustable calf stretcher device as claimed in claim 5 comprising:
the first support-wall lateral edge and the second support-wall lateral edge being oriented at an acute angle to each other;
the first support-wall lateral edge being longer than the second support-wall lateral edge;
the distal support-wall edge and the proximal support-wall edge being positioned parallel to each other; and
the distal support-wall edge being longer than the proximal support-wall edge.

8. The adjustable calf stretcher device as claimed in claim 1 comprising:
the first extension wall and the second extension wall each comprising an extension-wall body, a first extension-wall lateral edge, a second extension-wall lateral edge, a distal extension-wall edge, and a proximal extension-wall edge;
the first extension-wall lateral edge and the second extension-wall lateral edge being positioned opposite to each other across the extension-wall body;
the first extension-wall lateral edge being connected onto the base body;
the distal extension-wall edge being positioned adjacent to the distal base edge;
the proximal extension-wall edge being positioned adjacent to the proximal base edge; and
the plurality of base notches being distributed along the second extension-wall lateral edge, adjacent to the distal extension-wall edge.

9. The adjustable calf stretcher device as claimed in claim 8 comprising:
the second extension-wall lateral edge comprising a distal straight edge portion, a distal slanted edge portion, and a proximal slanted edge portion;
the plurality of base notches comprising a last base notch, a penultimate base notch, and a plurality of other base notches;
the distal straight edge portion being positioned parallel to the base body;
the distal straight edge portion being positioned adjacent to the distal extension-wall edge;
the distal slanted edge portion being positioned adjacent to the distal straight edge portion, opposite to the distal extension-wall edge;
the proximal slanted edge portion being positioned adjacent to the proximal extension-wall edge;
the distal slanted edge portion and the proximal slanted edge portion being oriented at an obtuse angle with each other;
the plurality of other base notches being integrated along the distal slanted edge portion; and
the last base notch and the penultimate base notch being integrated along the distal straight edge portion.

10. The adjustable calf stretcher device as claimed in claim 8 comprising:
the distal extension-wall edge and the proximal extension-wall edge being positioned parallel to each other; and
the distal extension-wall edge and the proximal extension-wall edge being positioned perpendicular to the first extension-wall lateral edge.

11. The adjustable calf stretcher device as claimed in claim 1 comprising:
the tilt-and-lock mechanism further comprising a first hinge pin and a second hinge pin;
the first support wall and the first extension wall being rotatably connected to each other by the first hinge pin;
the second support wall and the second extension wall being rotatably connected to each other by the second hinge pin;
the first hinge pin and the second hinge pin being positioned adjacent to the proximal platform edge and the proximal base edge; and
the first hinge pin and the second hinge pin being aligned to each other.

12. The adjustable calf stretcher device as claimed in claim 1 comprising:
the floor-bracing base further comprising a first base handle cutout;
the first support wall comprising a first support-wall handle cutout;
the first extension wall comprising a first extension-wall handle cutout;
the first base handle cutout peripherally traversing into the base body;
the first base handle cutout being positioned in between the proximal base edge and the distal base edge, adjacent to the first extension wall;
the first support-wall handle cutout laterally traversing into a support-wall body of the first support wall;
the first extension-wall handle cutout laterally traversing into an extension-wall body of the first extension wall; and
the first base handle cutout, the first support-wall handle cutout, and the first extension-wall handle cutout being aligned to each other.

13. The adjustable calf stretcher device as claimed in claim 1 comprising:
the floor-bracing base further comprising a second base handle cutout;
the second support wall comprising a second support-wall handle cutout;
the second extension wall comprising a second extension-wall handle cutout;
the second base handle cutout peripherally traversing into the base body;
the second base handle cutout being positioned in between the proximal base edge and the distal base edge, adjacent to the second extension wall;
the second support-wall handle cutout laterally traversing into a support-wall body of the second support wall;
the second extension-wall handle cutout laterally traversing into an extension-wall body of the second extension wall; and
the second base handle cutout, the second support-wall handle cutout, and the second extension-wall handle cutout being aligned to each other.

14. The adjustable calf stretcher device as claimed in claim 1 comprising:
at least one cross support wall;
the at least one cross support wall being connected perpendicular to the platform body; and
the at least one cross support wall being positioned in between the pair of support walls.

15. The adjustable calf stretcher device as claimed in claim 1 comprising:
the locking rod comprising a cylindrical body, a first nub, and a second nub;
the first nub being terminally connected to the cylindrical body;
the second nub being terminally connected to the cylindrical body, opposite to the first nub; and
the first nub and the second nub being engaged in between the selected base notch and the corresponding platform notch.

16. The adjustable calf stretcher device as claimed in claim 1 comprising:
an anti-slip layer; and
the anti-slip layer being mounted onto and across the platform body, opposite to the first support wall and the second support wall.
